(19) United States
(12) Patent Application Publication
(10) Pub. No.: US 2009/0212248 A1
(43) Pub. Date: Aug. 27, 2009

(54) Solenoid-actuated diaphragm valve

(76) Inventor: Eugeniusz Kozak, Mount Olive, NJ (US)

Correspondence Address: THOMAS J. GERMINARIO, ESQ., 154 ROUTE 206, CHESTER, NJ, 07930, US

(21) Appl. No.: 12/071,829

(22) Filed: Feb. 27, 2008

(51) Int. Cl. F16K 31/02

(52) U.S. Cl. 251/129.17; 251/227

(57) ABSTRACT

A solenoid-actuated diaphragm valve achieves minimal dead volume, tolerance of high pressures, prolonged diaphragm life, and energy conservation using a three-sector multi-seal diaphragm combined with a three-component plunger, which automatically switches from bilateral to unilateral circumferential diaphragm restraint between the closed and open positions.

### FIELD OF THE INVENTION

The present invention relates to valves that control fluid flow by using a flexible diaphragm to seal one or more fluid passages, and more particularly to valves in which the sealing diaphragm is deformed through the application of a biasing force transmitted by the movement of a solenoid armature.

### BACKGROUND OF THE INVENTION

Solenoid-actuated diaphragm valves are widely used in fluid distribution systems to control fluid flow. In isolation valves, the fluid can be isolated and channeled to designated passages and/or chambers within the valve through the displacement of a flexible diaphragm. The displacement of the diaphragm typically causes it to engage or disengage with a valve seat where two or more fluid passages terminate. Typically, in the neutral or de-energized condition, the diaphragm engages the valve seat sufficiently to seal one or more of the fluid passages, thereby interrupting or redirecting the fluid flow through the valve. The neutral bias to maintain the diaphragm in the engaged position is most often provided by a compressed helical spring.

Again in the typical isolation valve, the energized condition is one in which the diaphragm disengages from the valve seat sufficiently to allow fluid to flow between two or more of the passages. The biasing means most often applied to cause the diaphragm to disengage is the armature of an electromechanical solenoid. The solenoid assembly contains a solenoid coil, which typically has an annular cylindrical configuration. A ferromagnetic solid cylindrical armature is slidably positioned in the center of the solenoid coil, such that the armature can move in and out of the center, thereby causing the coil's inductance to increase (as the armature advances further into the center) or decrease (as the armature withdraws further from the center). When the solenoid coil is energized, the armature will experience a force which is proportional to the change in inductance of the coil with respect to the change in position of the armature. Therefore, the force generated by the energized solenoid coil will move the armature to a position that increases the inductance of the coil, i.e., further into the center of the coil.

In isolation valves, the armature is typically a solid cylindrical core of iron or steel referred to a “plunger”. Most often, the distal end of the plunger is connected to the helical spring, the force of which urges the plunger against the diaphragm in the de-energized state, corresponding to the closed position of the valve. In the energized state, the plunger is pulled up into the center of the solenoid coil through a cylindrical cavity known as the “plunger guide”. In this withdrawn position, the plunger may either release its pressure on the diaphragm or pull the diaphragm up with it, in either case thereby disengaging the diaphragm from the valve seat and opening the fluid passages.

While the configuration of the solenoid assembly is fairly standardized for isolation valves, there are a number of possible configurations for the plunger, the diaphragm and the valve seat. The arrangement of these elements will determine the volume of fluid that is retained inside the valve when it is in the closed position—commonly referred to as “dead volume”. Because of the potential for contamination of the fluid and/or corrosion of the valve components, dead volume is undesirable and should be minimized. Another variable that depends on the valve configuration is the degree of deformation of the diaphragm as it flexes between the engaged and disengaged positions. Limited deformation is more desirable because it reduces fatigue of the elastomeric material which can cause diaphragm failure over time. Yet another factor to consider is the length of the plunger stroke—that is, the distance through which the plunger must be withdrawn upward through the plunger guide to effect the disengagement of the diaphragm from the valve seat. A shorter plunger stroke is preferable because it consumes less electrical energy, allows quicker response time, and reduces component wear.

In the prior art, there are several alternate configurations for the plunger, the diaphragm and the valve seat. On one end of the spectrum, we find configurations in which the plunger terminates in a needle valve or poppet structure that engages the valve seat and is surrounded or enclosed by the diaphragm. Examples of such “integral diaphragm” configurations are disclosed in Delaporte et al., U.S. Pat. No. 3,098,635, Huley et al., U.S. Pat. No. 3,429,552, and Gilchrist et al., U.S. Pat. Nos. 5,333,643 and 5,386,849. On the other end of the spectrum, there are configurations in which the plunger is not attached to the diaphragm but merely pushes it against the valve seat in the de-energized state. Such “detached diaphragm” configurations are taught by Holtermann, U.S. Pat. No. 4,944,487, Kazama et al., U.S. Pat. No. 5,470,045, and Sule, U.S. Pat. No. 5,546,987. In Allen, U.S. Pat. No. 4,295,631, the de-energized plunger does not push the diaphragm, but instead closes a pilot valve extending through the center of the diaphragm, thereby creating an unbalanced fluid pressure above the diaphragm which urges it against the valve seat.

There are a host of problems associated with both the “integral diaphragm” and “detached diaphragm” designs. The integral diaphragms, as taught by Delaporte and Huley, involve considerable dead volume, long plunger strokes and severe diaphragm deformation. While Gilchrist avoids these problems, it does so at the cost of a quite constricted fluid passage through the valve seat in the open position, which will retard the fluid flow and create pressure build-upon the diaphragm. As for the detached diaphragm designs, Allen and Sule achieve a short plunger stroke but involve considerable dead volume. While Holtermann and Kazama achieve both a short plunger stroke and minimal dead volume, they rely critically on the alignment of the plunger with the center of the diaphragm, which is likely to deviate over time. Moreover, repeated impact on the plunger on the center of the diaphragm will produce scoring and accelerate fatigue failure over time.

Both Holtermann and Kazama have the additional drawback of employing diaphragms having a uniform cross-sectional area. Such diaphragms must flex upward away from the valve seat when the plunger pressure is withdrawn in the energized state. Because such diaphragms must retain resiliency across their entire cross section, they cannot be thickened to withstand high pressure and are prone to failure when fluid pressure exceeds certain limits. Although Gilchrist teaches a non-uniform diaphragm cross-section, one of the thickened portions of the diaphragm surrounds the periphery of the plunger poppet, where deformation will be most concentrated when the poppet moves downward to engage the valve seat. This is inefficient, since the diaphragm cross-section should be thinnest in the area where most of the deformation occurs.

Yet another detached diaphragm design is disclosed by Kleinhappl, U.S. Pat. No. 5,265,843, but in this case a variable diaphragm cross-section is taught. A thick-walled central section of the diaphragm is surrounded by an annular thin-walled medial “wing” area which deforms when the valve is closed. Surrounding the medial wing area of the diaphragm, in turn, is a thickened peripheral bead designed to be secured between the valve body and the solenoid housing. In this design, the central section of the diaphragm forms an obtuse poppet-like projection that engages the central fluid passage of the valve seat in the de-energized state. As can be seen in FIG. 6, however, the combination of this blunt central projection and the pronounced upward flexing of the medial wing area leaves a considerable dead volume when the valve is closed. This suggests that a better design for a variable cross-section diaphragm would be one in which the medial wing flexes upward in the energized state—that is, when the valve is open rather than closed—so that the expanded area under the upwardly flexed wing relieves pressure and promotes even fluid flow, rather than creating a dead volume.

Shirkhan, U.S. Pat. No. 6,089,538, also discloses a diaphragm having a variable cross-section, with a thickened flat central portion and peripheral sealing bead joined by a thin, flexible medial wing section. This medial wing of the diaphragm is capable of flexing more readily and thus relieving pressure from the central and peripheral sections. But, in order to produce an effective seal, the flat surface of the central portion of the diaphragm requires a specially designed valve seat in which tubes extend from the fluid passages above the surface of the valve seat. Shirkhan does represent an advance over the prior art, however, insofar as it teaches a diaphragm that is neither integral with nor detached from the plunger. Instead, the diaphragm has a threaded post-like structure at the center of its reverse side, by means of which the diaphragm is screwed into a threaded recess in the proximal end of the plunger. This “attached diaphragm” design has distinct advantages, because the diaphragm can now move in secure alignment with the plunger while at the same time having a shape unconstrained by the plunger structure.

It should be noted that in the closed position, the diaphragm may seal either one or both of the fluid passages in the valve seat. In a two-port isolation valve, there are two apertures in the valve seat—a valve seat inlet connecting to the inlet port in the valve body and a valve seat outlet connecting to the outlet port in the valve body. The valve seat inlet can be located at the center of the valve seat, with the outlet at the periphery, or vice versa. If we consider the prior art designs in which the diaphragm seals only the central valve seat inlet/outlet, we find that these designs all have a relatively high dead volume, due to the area left unsealed between the diaphragm and the peripheral valve seat outlet/inlet. Examples of this pattern of high dead volume for “single seal” diaphragms can be seen in Delaporte, Huley, Allen, Kleinhappl, and Sule. On the other hand, prior art designs featuring “double seal” diaphragms, which cover both the valve seat inlet and outlet, tend to have minimal dead volume. Illustrations of the latter are Holtermann, Gilchrist, Kazama, and Shirkhan.

Summarizing the foregoing review of the prior art, the following objectives must be achieved in an optimal solenoid valve design:
1. minimal dead volume in the closed position
2. small displacement of the diaphragm between open and closed positions
3. a short plunger stroke to effect valve opening
4. a diaphragm designed to withstand high pressure

In order to achieve the foregoing objectives, the following design features are imperative:
1. a variable diaphragm cross-section, with thickened central and peripheral areas and thin, flexible medial wing;
2. the center area of the diaphragm is attached to the proximal end of the plunger;
3. the medial wing of the diaphragm flexes upward in the open position;
4. the central area of the diaphragm protrudes downward toward the valve seat; and
5. a “double seal” diaphragm, sealing both the valve seat inlet and outlet in the closed position

The problem that arises in implementing these five design features relates to the method of securing the circumference of the diaphragm. In all prior art designs, the circumference of the diaphragm is secured between the valve body and the solenoid housing. Consequently, the prior art teachings all have the peripheral area of the diaphragm constrained to a horizontal alignment in both the open and closed positions of the valve. But the optimal design outlined above requires that the un-flexed diaphragm engage the valve seat both at the center and at the periphery, in order to seal both the central and peripheral inlet/outlet apertures. Therefore, if the peripheral area of the diaphragm remains constrained to a horizontal alignment through the entire valve cycle, the peripheral area of the diaphragm cannot flex upward from the valve seat to uncover the peripheral inlet/outlet aperture in order to open the valve. This is particularly true if the peripheral diaphragm area is thickened to withstand high pressure.

Hence, there is a need for a method of securing the circumference of the diaphragm so that its peripheral area is held securely against the valve seat when the valve is closed but is free to flex upward away from the valve seat when the valve is opened. This need is addressed in the present invention by providing a composite plunger, comprising a cylindrical plunger core, from the proximal end of which extends a plunger shaft. Attached to the proximal end of the plunger shaft is a diaphragm. Slidably attached to the plunger shaft is a plunger plate, which is cylindrical or disk-shaped and moves freely between the proximal end of the plunger shaft and the diaphragm.

This composite plunger operates as follows: When the valve is closed and the solenoid is de-energized, the center of the diaphragm is pushed against the valve seat and into the central inlet/outlet aperture by the force of a spring that engages the distal end of the plunger core and transmits its force to the diaphragm through the plunger shaft. The circumference of the diaphragm has a narrow circumferential flange that engages a corresponding shallow circumferential notch in the valve seat. In the de-energized state, the full weight of the plunger plate bears down on the peripheral area of the diaphragm and holds it flush against the valve seat, thereby enabling the peripheral area of the diaphragm to effectively seal the peripheral inlet/outlet.

When the valve is open and the solenoid is energized, the plunger core is drawn up through the plunger guide into the center of the solenoid coil. Because the plunger core is a made of a ferromagnetic material, it becomes magnetized when it is within the solenoid coil. The magnetized plunger core attracts the plunger plate, which is also made of a ferromagnetic material. The plunger plate is drawn upward along the plunger shaft toward the plunger core, thereby relieving the downward pressure on the peripheral area of the diaphragm and allowing it to flex upward in response to the upward pull of the ascending plunger shaft attached to the central area of the diaphragm.

In the present invention, the diaphragm is specifically designed to work in concert with the composite plunger described above. The diaphragm comprises a rigid, acute central projection, surrounded by a thin, flexible, narrow medial wing, which is in turn surrounded by a thickened, semi-rigid, wide peripheral band having the circumferential flange described above. The diaphragm of the present invention differs from those taught by the prior art in that the peripheral band is thicker and much wider, extending across one-half or more of the diaphragm's cross-section. Conversely, in this invention the medial wing of the diaphragm is thinner and much narrower than in the prior art designs. Moreover, the central projection of the present invention's diaphragm has an acute shape, preferably conical, unlike the obtuse central projections of the prior art diaphragms, such as Huley, Allen, Kleinhappl, Sule, and Shirkhan.

By virtue of the unique diaphragm design of the present invention, the flexing of the medial wing allows the central projection to move up and down in response to the motion of the plunger shaft, thereby opening and closing the central valve seat inlet/outlet. Meanwhile, the width and thickness of the peripheral band enables it to seal the peripheral valve seat inlet/outlet effectively, even in high pressure flow conditions. The lack of bilateral rigid clamping of the circumference of the diaphragm is compensated, in the closed position, by the weight of the plunger plate on the reverse side of the peripheral band. When this weight is released by the magnetic attraction between the plunger plate and the plunger core, the semi-rigid peripheral band can flex slightly upward and pivot on the circumferential flange enough to disengage from the peripheral valve seat inlet/outlet.

Consequently, the unique features of the present invention enable it to achieve the aims of low dead volume, minimal diaphragm displacement, short plunger stroke, and ability to withstand high pressure, far better than the prior art designs. The many advantages of the present invention will be explained in more detail in the next section.

### SUMMARY OF THE INVENTION

In order to simplify the discussion of the features of the present invention, we will refer to a two-port solenoid valve having a valve seat with a central inlet and a peripheral outlet. This does not imply any limitation of the scope of the present invention, which is applicable to any multi-port solenoid valve and any valve seat configuration.

An object of the present invention is to provide a solenoid-actuated diaphragm valve that minimizes the “dead volume” of fluid that is retained inside the valve when it is in the closed position, thereby reducing the potential for contamination of the fluid and/or corrosion of the valve components.

Another object of the present invention is to provide a solenoid-actuated diaphragm valve that limits the degree of deformation of the diaphragm as it flexes between the engaged and disengaged positions, thereby reducing fatigue of the elastomeric material which can cause diaphragm failure over time.

A further object of the present invention is to provide a solenoid-actuated diaphragm valve that operates with a short plunger stroke, that is, a short distance through which the plunger must be withdrawn upward through the plunger guide to effect the disengagement of the diaphragm from the valve seat, thereby consuming less electrical energy, enabling quicker valve response time, and reducing component wear.

Yet another object of the present invention is to provide a solenoid-actuated diaphragm valve in which the diaphragm can withstand high fluid pressure, and more specifically one in which the diaphragm has a variable cross-section, with a semi-rigid “peripheral band” area located where fluid pressure is concentrated and a resilient “wing” area located where flexing is required.

Yet a further object of the present invention is to provide a solenoid-actuated diaphragm valve in which the diaphragm can withstand high fluid pressure, and more specifically one in which the diaphragm has a rigid, acute central projection that extends into the central valve seat inlet in the closed position.

Still another object of the present invention is to provide a solenoid-actuated diaphragm valve in which the resilient “wing” area of the diaphragm flexes upward in the energized state (open position), so that the expanded area under the upwardly flexed wing relieves pressure and promotes even fluid flow, rather than creating a dead volume, as would be the case if the wing flexed upward in the closed position.

Still a further object of the present invention is to provide a solenoid-actuated diaphragm valve in which the semi-rigid “peripheral band” of the diaphragm is secured against vertical deflection in both directions (i.e., up and down) in the closed position, thereby effecting a pressure-resistant seal over the peripheral valve seat outlet, but in which the peripheral band is able to flex slightly upward in the open position, thereby disengaging from the peripheral valve seat outlet.

These and other beneficial objectives are achieved by the present invention by virtue of the following unique features:

1. A “double seal” diaphragm that seals both the central valve seat inlet and the peripheral valve seat outlet in the closed position and leaves virtually no dead volume. The diaphragm has a post-like structure at the center of its reverse side, by means of which the diaphragm is attached to a recess in the proximal end of the plunger shaft. This “attached diaphragm” design allows the diaphragm to move in secure alignment with the plunger while at the same time having a shape unconstrained by the plunger structure.

2. A variable diaphragm cross-section comprising three functionally different areas: (a) a rigid, acute central projection, preferably conical, which is directly connected to the plunger shaft and where the maximum upward displacement of the diaphragm takes place as the plunger rises in the energized state; (b) a thin, flexible, narrow medial wing, which surrounds the central projection and enables it to have a greater upward displacement than the diaphragm as a whole; and (c) a thickened, semi-rigid, wide peripheral band, which has a narrow circumferential flange that engages a corresponding shallow circumferential notch in the valve seat.

3. A composite plunger, comprising: (a) a cylindrical plunger core, made of a ferromagnetic material and slidably positioned within a plunger guide that passes through the center of the solenoid coil, the distal end of which plunger core is engaged by a compressed helical spring which urges the plunger core downward toward the valve seat when the solenoid coil is de-energized; (b) a plunger shaft, which extends from the proximal end of the plunger core and is attached to the diaphragm through a post that extends from the back of the central projection, and which pulls the diaphragm upward away from the valve seat when the solenoid coil is energized and the plunger core is drawn upward; and (c) a cylindrical or disk-shaped, ferromagnetic plunger plate, slidably attached to the plunger, which plunger plate presses downward against the peripheral band of the diaphragm and secures its circumference against upward deflection when the solenoid coil is de-energized, but which moves upward and releases its pressure on the peripheral band of the diaphragm when the solenoid coil is energized and the plunger core becomes magnetized.

The lack of clamping of the circumference of the diaphragm in the upward direction is thus compensated, in the closed position, by the weight of the plunger plate on the peripheral band. When this weight is released by the magnetic attraction between the plunger plate and the plunger core, the semi-rigid peripheral band can flex slightly upward and pivot on the circumferential flange enough to disengage from the peripheral valve seat outlet.

The functional role of the foregoing features will be explicated further by the following drawings and detailed description of the preferred embodiment of the present invention.

### BRIEF DESCRIPTION OF THE DRAWINGS

FIG. 1 is an axial section view of a solenoid-actuated diaphragm valve in accordance with the first preferred embodiment of the present invention, which valve is depicted in the closed position (de-energized state).

FIG. 2 is an axial section view of a solenoid-actuated diaphragm valve in accordance with the first preferred embodiment of the present invention, which valve is depicted in the open position (energized state).

FIG. 3 is an axial section view of a composite plunger, with a diaphragm attached to the proximal end thereof, and a valve body of a solenoid-actuated diaphragm valve in accordance with the first preferred embodiment of the present invention.

FIG. 4 is an axial section view of a solenoid-actuated diaphragm valve in accordance with the second preferred embodiment of the present invention, which valve is depicted in the closed position (de-energized state).

FIG. 5 is an axial section view of a solenoid-actuated diaphragm valve in accordance with the second preferred embodiment of the present invention, which valve is depicted in the open position (energized state).

FIG. 6 is an axial section view of a composite plunger, with a diaphragm attached to the proximal end thereof, and a valve body of a solenoid-actuated diaphragm valve in accordance with the second preferred embodiment of the present invention.

### DETAILED DESCRIPTION OF THE PREFERRED EMBODIMENTS

In the following detailed description of the two preferred embodiments, it should be understood that the novel features of the present invention relate to the plunger and the diaphragm, and that the other features described herein are merely typical features of a generic solenoid-actuated diaphragm valve. Therefore, the configuration of the various elements of the valve other than the plunger and the diaphragm are for illustrative and exemplary purposes only, and are not intended to limit the scope of the present invention. Thus, for example, while a specific configuration of the valve body and valve seat is described herein, this configuration can be varied to according to the desired flow pattern of the valve without impairing the utility or applicability of the present invention.

As used in the following description, the term “proximal” refers to the part of an element oriented toward the base of the valve, while the term “distal” refers to the part of an element oriented toward the top of the valve. Similarly, the terms “up” and “upward” refer to the direction toward the top of the valve, while the terms “down” and “downward” refer to the direction toward the base of the valve.

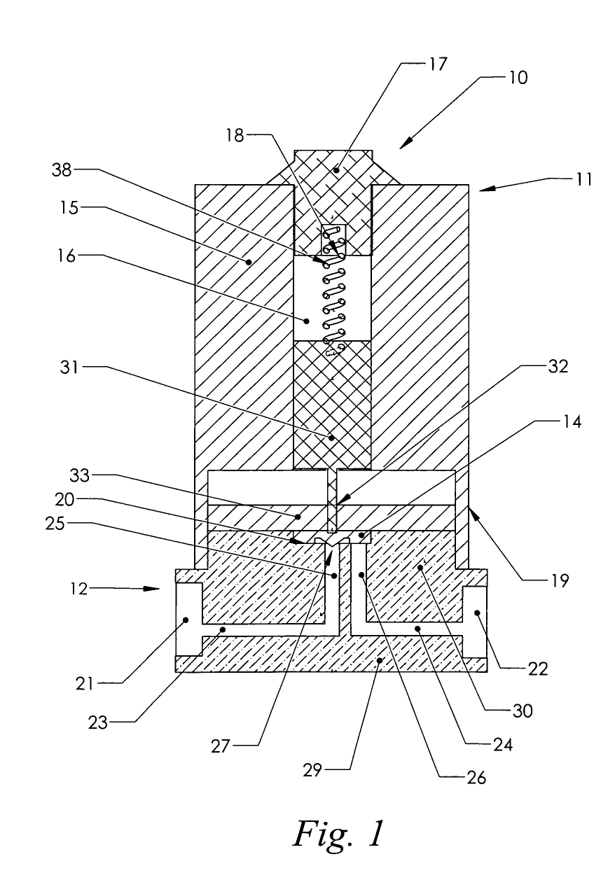

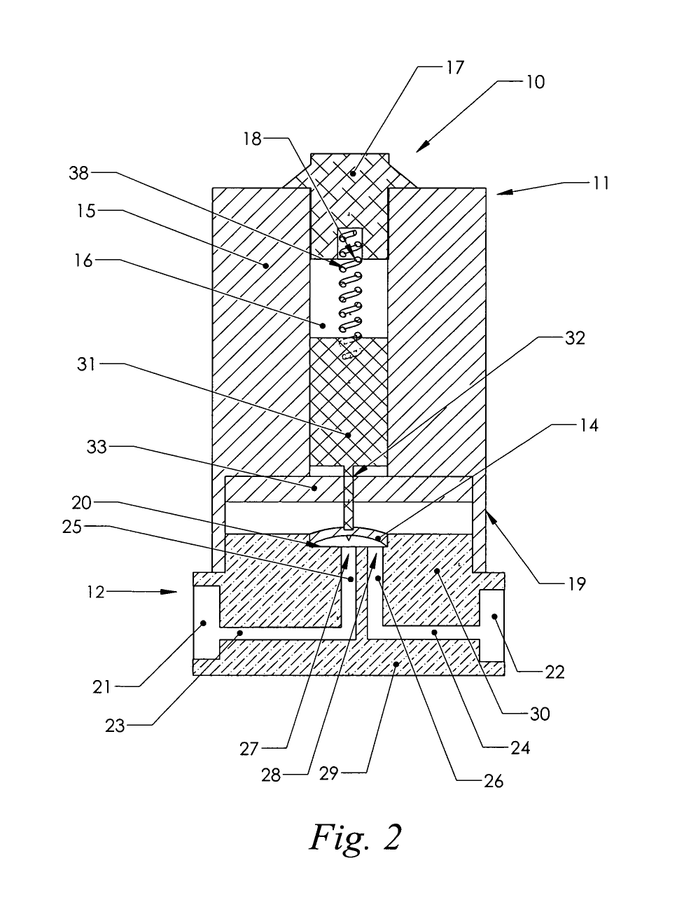

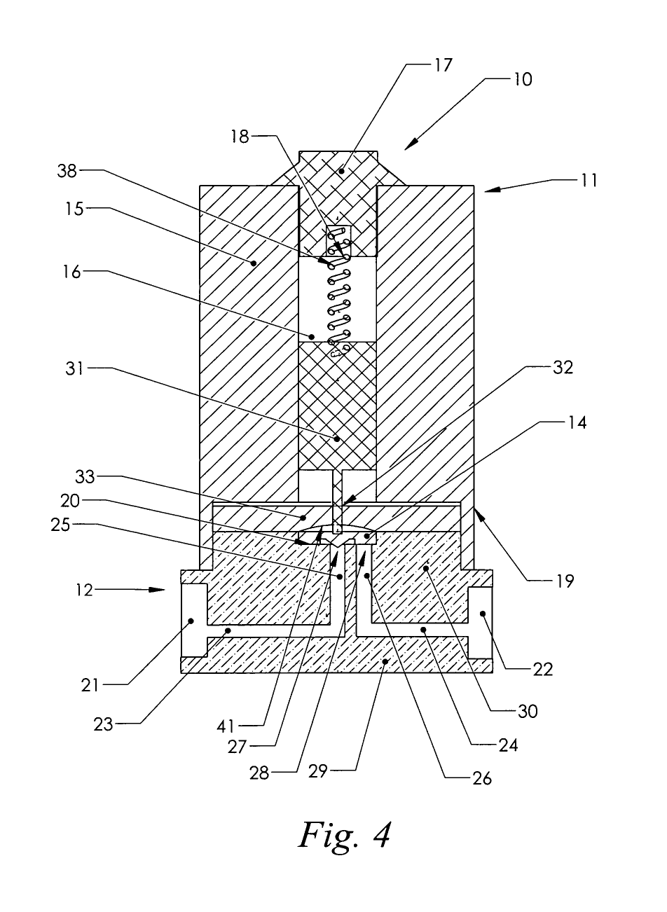

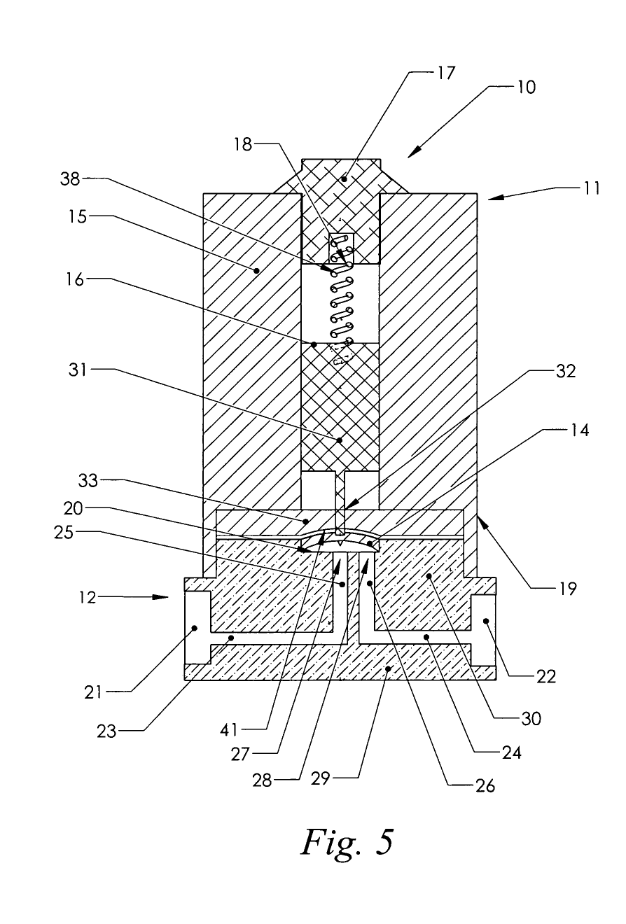

As shown in FIG. 1 and FIG. 2 and in FIG. 4 and FIG. 5, a solenoid-actuated diaphragm valve according to both the first and second preferred embodiments of the present invention 10 comprises a solenoid assembly 11, a valve body 12, a plunger 13, and a diaphragm 14. The solenoid assembly 11 comprises a solenoid coil 15, a plunger guide 16, a solenoid lid 17, a spring 18, and solenoid housing 19. The valve body 12 comprises a valve seat 20, an inlet port 21, an outlet port 22, a radial inlet bore 23, a radial outlet bore 24, an axial inlet bore 25, an axial outlet bore 26, a valve seat inlet 27, a valve seat outlet 28, a valve body base 29, and valve body neck 30.

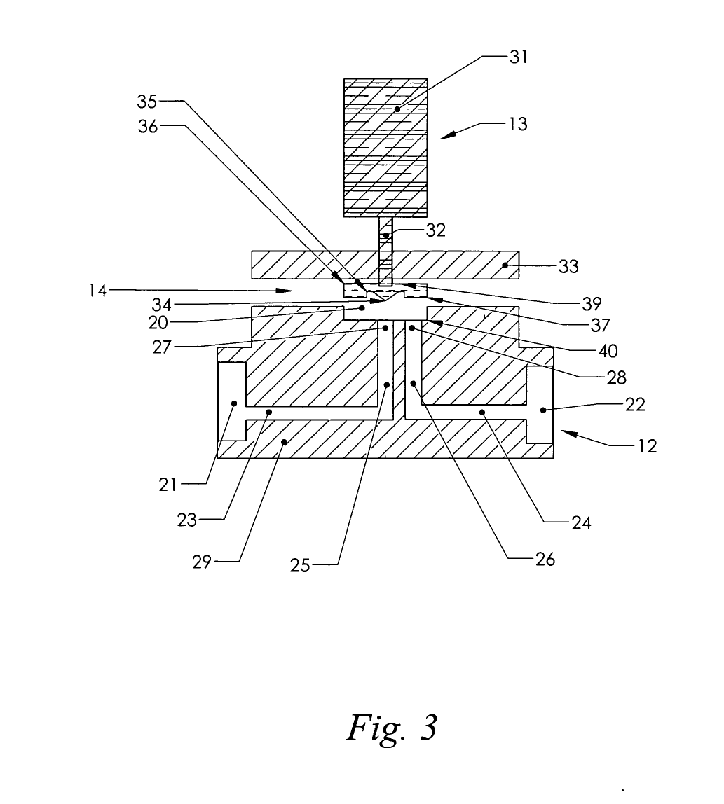

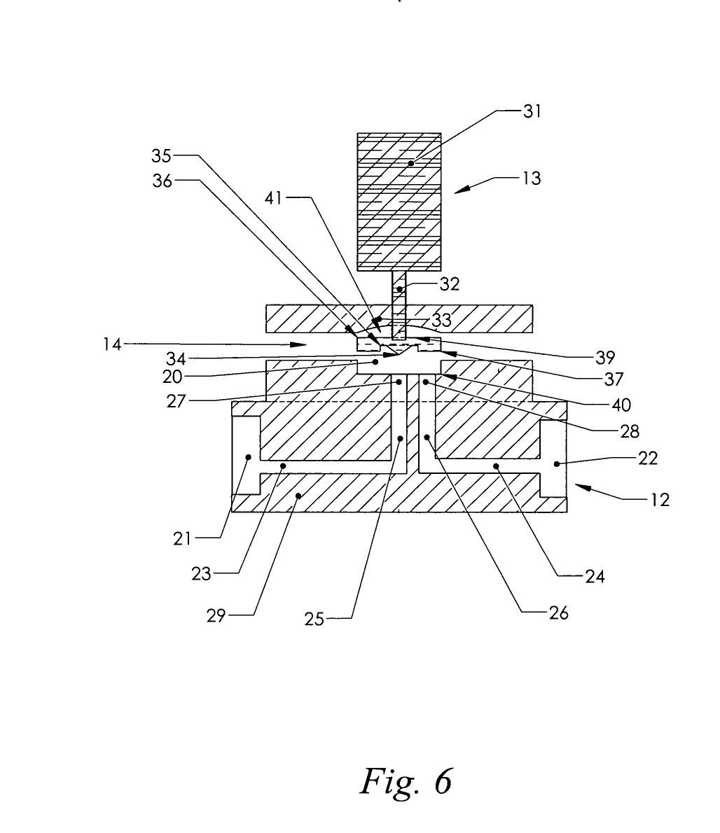

Referring to FIG. 3 and FIG. 6, the plunger comprises a plunger core 31, a plunger shaft 32, and a plunger plate 33. The diaphragm 14 comprises a central projection 34, a medial wing 35, a peripheral band 36, and a circumferential flange 37.

The solenoid coil 15 is a coil of wire having an annular cylindrical configuration and surrounding the plunger guide 16, which is a cylindrical passage axially aligned within the solenoid coil 15. At the distal end of the solenoid coil 15 is a solenoid lid 17, which is a short, cylindrical, ferromagnetic plug. The solenoid lid 17 has at its proximal end an axial spring bore 38, into which the distal end of the spring 18 is inserted. The proximal end of the spring 18 engages the distal end of the plunger core 31. Optionally, the proximal end of the spring 18 can be inserted into an axial bore (not shown) in the distal end of the plunger core 31.

The distal end of the solenoid lid 17 is externally threaded so as to screw into an internally threaded frustrum-shaped extension of the distal end of the solenoid housing 19. The solenoid housing 19 is a rigid cylindrical structure that encapsulates all the other components of the solenoid assembly 11. The proximal end of the solenoid housing 19 is internally threaded so as to screw into the externally threaded valve body neck 30.

The valve body neck 30 is a short cylindrical structure integral with the distal end of the valve body base 29 and having a diameter approximately two-thirds that of the valve body base 29. At the center of the distal surface of the valve body neck 30 is the valve seat 20, which is a shallow circular bore, approximately 0.05 to 0.1 cm in depth with a diameter approximately half that of valve body neck 30. Located at the center of the valve seat 20 is the valve seat inlet 27, which is an aperture communicating with the axial inlet bore 25, which in turn communicates with the radial inlet bore 23, which in turn communicates with the inlet port 21, which penetrates the exterior surface of the valve body base 29. Located off-center in the valve seat 20 is the valve seat outlet 28, which is an aperture communicating with the axial outlet bore 26, which in turn communicates with the radial outlet bore 24, which in turn communicates with the outlet port 22, which penetrates the exterior surface of the valve body base 29 on the side opposite to the inlet port 21. The inlet port 21 and outlet port 22 have internal threads for connecting the valve body 12 to external inlet and outlet conduits (not shown) in the conventional manner.

The plunger core 31 is a cylinder of ferromagnetic material which is slidably positioned within the plunger guide 16. The distal end of the plunger core 31 is engaged by the spring 18 which urges the plunger core 31 downward against the valve seat 20 when the solenoid coil 15 is de-energized. Extending from the proximal end of the plunger core 31 is the plunger shaft 32, which is attached to the diaphragm 14 by a diaphragm post 39. The diaphragm post 39 extends upward from the distal end of the central projection 34 of the diaphragm 14. The plunger shaft 32 pulls the diaphragm 14 upward away from the valve seat 20 when the solenoid coil 15 is energized and the plunger core 31 is drawn upward through the plunger guide 16.

Slidably attached to the plunger shaft 32 is the disk-shaped, ferromagnetic plunger plate 33, which presses downward against the peripheral band 36 of the diaphragm 14 and prevents it from deflecting upward when the solenoid coil 15 is de-energized, thereby keeping the peripheral band 36 securely engaged against the valve seat outlet 28 in order to close the valve, as shown in FIG. 1 and FIG. 4. But when the solenoid coil is energized and the plunger core 31 becomes magnetized, the plunger plate 33 moves upward and releases its pressure on the peripheral band 36 of the diaphragm 14, thereby allowing the peripheral band 36 to flex slightly upward and uncover the valve seat outlet 28 in order to open the valve, as shown in FIG. 2 and FIG. 5.

The differences between the first preferred embodiment of the present invention 10, which is illustrated in FIGS. 1-3, and the second preferred embodiment, which is illustrated in FIGS. 1-4, are in the lengths of their respective plunger strokes and in the shapes of the proximal face of the plunger plate 33. In the first preferred embodiment, the proximal face of the plunger plate 33 is flat, while in the second preferred embodiment, the proximal face of the plunger plate 33 has a central concavity 41. In the second preferred embodiment, the central concavity 41 of the plunger plate 33 allows the diaphragm 14 to flex upward sufficiently to uncover the valve seat inlet 27 and outlet 28, and thus open the valve, with less upward displacement of the plunger core 31 than is required to open the valve in the first preferred embodiment. Therefore, the second preferred embodiment achieves a shorter plunger stroke and less diaphragm deflection than the first preferred embodiment.

The diaphragm 14 is disk-shaped, about 0.7 cm in diameter, fabricated of a resilient elastomeric material, such as PTFE (polytetrafluoroethylene), and it has a variable cross-section comprising three functionally distinct areas. A rigid, acute central projection 34, preferably conical in shape, is connected through the diaphragm post 39 to the plunger shaft 32. Preferably, the central projection 34 has a depth of approximately 0.2 cm to 0.3 cm and a diameter at its base of approximately 0.1 cm to 0.2 cm. When the valve is closed, the central projection 34 extends down into the valve seat inlet 27, thereby sealing it, as shown in FIG. 1 and FIG. 4.

The medial wing 35 surrounds the central projection 34 and enables it to have a greater upward displacement than the diaphragm as a whole. When the valve is opened, as shown in FIG. 2 and FIG. 5, the maximum upward displacement of the diaphragm 14 takes place at the central projection 34, as the plunger core 31 moves upward in the energized state. This upward displacement of the central projection 34 is enabled by the deformation of the medial wing 35, which is thin, flexible and narrow. Preferably, the medial wing has a thickness of approximately 0.005 cm to 0.008 cm and a width of approximately 0.03 cm to 0.05 cm.

Surrounding the medial wing 35 in the diaphragm 14 is the peripheral band 36, which is thickened, semi-rigid, and wide. Preferably, the peripheral band has a thickness of approximately 0.06 cm to 0.08 cm and a width of approximately 0.3 cm. In the closed position, as shown in FIG. 1 and FIG. 4, the peripheral band 36 is urged downward against the valve seat 20 by the weight of the plunger plate 33, thereby sealing the valve seat outlet 28. In the open position, as shown in FIG. 2 and FIG. 5, the downward weight of the plunger plate 33 on the peripheral band 36 is released, as the plunger plate 33 is attracted upward along the plunger shaft 32 by the magnetized plunger core 31, thereby allowing the peripheral band 36 to flex slightly upward and uncover the valve seat outlet 28. The peripheral band has a narrow circumferential flange 37 that engages a corresponding shallow circumferential notch 40 in the valve seat 20, thereby keeping the diaphragm 14 attached at its circumference to the circumference of the valve seat 20 when the valve is open.

While this invention has been described with reference to two specific embodiments, the description is not to be construed in a limiting sense. Various modifications of the disclosed embodiment, as well other embodiments of the invention, will be apparent to persons skilled in the art upon reference to this description. It is therefore contemplated that the appended claims will cover any such modifications or embodiments that fall within the true scope of this invention.

What is claimed is:

1. A solenoid-actuated diaphragm valve, comprising:
(a) a solenoid coil having a cylindrical interior cavity, within which is slidably inserted a cylindrical ferromagnetic armature, which armature has at its proximal end an armature shaft, and which armature is engaged at its distal end by a biasing means, such that when the solenoid coil is not energized, the biasing means urges the armature downward through the interior cavity, and such that when the solenoid coil is energized, the inductance of the solenoid coil draws the armature upward through the interior cavity and causes the armature to become magnetized;
(b) a valve body comprising two or more flow passages, which flow passages communicate with each other through a valve seat;
(c) a flexible, disk-shaped diaphragm, which is attached to the proximal end of the armature shaft, and which diaphragm is sealingly engageable with the valve seat, such that when the solenoid coil is not energized, the downward action of the armature shaft causes the diaphragm to engage the valve seat sufficiently to seal one or more of the flow passages, and such that when the solenoid coil is energized, the upward action of the armature shaft causes the diaphragm to disengage from the valve seat sufficiently to unseal one or more of the flow passages; and
(d) a cylindrical or disk-shaped ferromagnetic plate, which is slidably attached to the armature shaft, such that when the solenoid coil is not energized, the weight of the plate is exerted downward upon the diaphragm, thereby pressing the diaphragm against the valve seat, and such that when the solenoid valve is energized, the armature magnetically attracts the plate and draws the plate upward along the armature shaft, thereby removing the downward pressure of the plate upon the diaphragm and allowing the diaphragm to disengage from the valve seat sufficiently to unseal one or more of the flow passages.

2. The solenoid-actuated diaphragm valve according to claim 1, wherein the diaphragm has a central projection, the distal side of which is attached to the proximal end of the armature shaft, such that when the solenoid coil is not energized, the central projection engages the valve seat so as to seal one or more of the flow passages, and such that when the solenoid coil is energized, the central projection is displaced upward and disengages from the valve seat so as to unseal one or more of the flow passages.

3. The solenoid-actuated diaphragm valve according to claim 2, wherein the central projection is surrounded by a narrow, resilient medial band having a thickness much less than that of the central projection, such that when the solenoid coil is energized, the medial band flexes upward, thereby facilitating the upward displacement of the central projection.

4. The solenoid-actuated diaphragm valve according to claim 3, wherein the medial band is surrounded by a broad peripheral band having a thickness less than that of the central projection but much greater than that of the medial band, such that when the solenoid coil is not energized, the peripheral band engages the valve seat so as to seal one or more of the flow passages, and such that when the solenoid coil is energized, the peripheral band flexes upward sufficiently to unseal one or more of the flow passages.

5. The solenoid-actuated diaphragm valve according to claim 4, wherein the peripheral band has one or more circumferential flanges that fit snugly into one or more corresponding circumferential notches in the valve seat, thereby securing the circumference of the peripheral band to the valve seat.

6. The solenoid-actuated diaphragm valve according to any of claims 1-5, wherein the plate has at the center of its proximal face a concave depression, into which concave depression the diaphragm flexes upward when the solenoid coil is energized and disengages from the valve seat so as to unseal one or more of the flow passages.

7. The solenoid-actuated diaphragm valve according to any of claims 1-5, wherein the biasing means is a spring.

8. The solenoid-actuated diaphragm valve according to claim 6, wherein the biasing means is a spring.

9. The solenoid-actuated diaphragm valve according to any of claims 1-5, wherein the central projection has a conical shape.

10. The solenoid-actuated diaphragm valve according to claim 6, wherein the central projection has a conical shape.

11. The solenoid-actuated diaphragm valve according to claim 8, wherein the central projection has a conical shape.

12. A solenoid-actuated diaphragm valve, comprising:
(a) a solenoid coil having a cylindrical interior cavity, within which is slidably inserted a cylindrical ferromagnetic armature, which armature has at its proximal end an armature shaft, and which armature is engaged at its distal end by a biasing means, such that when the solenoid coil is not energized, the biasing means urges the armature downward through the interior cavity, and such that when the solenoid coil is energized, the inductance of the solenoid coil draws the armature upward through the interior cavity and causes the armature to become magnetized;
(b) a valve body comprising two flow passages, which flow passages communicate with each other through a valve seat;
(c) a flexible, disk-shaped diaphragm, which is attached to the proximal end of the armature shaft, and which diaphragm is sealingly engageable with the valve seat, such that when the solenoid coil is not energized, the downward action of the armature shaft causes the diaphragm to engage the valve seat sufficiently to seal both of the flow passages, and such that when the solenoid coil is energized, the upward action of the armature shaft causes the diaphragm to disengage from the valve seat sufficiently to unseal both of the flow passages; and
(d) a cylindrical or disk-shaped ferromagnetic plate, which is slidably attached to the armature shaft, such that when the solenoid coil is not energized, the weight of the plate is exerted downward upon the diaphragm, thereby pressing the diaphragm against the valve seat, and such that when the solenoid valve is energized, the armature magnetically attracts the plate and draws the plate upward along the armature shaft, thereby removing the downward pressure of the plate upon the diaphragm and allowing the diaphragm to disengage from the valve seat sufficiently to unseal both of the flow passages.

13. The solenoid-actuated diaphragm valve according to claim 12, wherein the two flow passages terminate at the surface of the valve seat in a central flow aperture and a peripheral flow aperture.

14. The solenoid-actuated diaphragm valve according to claim 13, wherein the diaphragm has a central projection, the distal side of which is attached to the proximal end of the armature shaft, such that when the solenoid coil is not energized, the central projection engages the valve seat so as to seal the central flow aperture, and such that when the solenoid coil is energized, the central projection is displaced upward and disengages from the valve seat so as to unseal the central flow aperture.

15. The solenoid-actuated diaphragm valve according to claim 14, wherein the central projection is surrounded by a narrow, resilient medial band having a thickness much less than that of the central projection, such that when the solenoid coil is energized, the medial band flexes upward, thereby facilitating the upward displacement of the central projection.

16. The solenoid-actuated diaphragm valve according to claim 15, wherein the medial band is surrounded by a broad peripheral band having a thickness less than that of the central projection but much greater than that of the medial band, such that when the solenoid coil is not energized, the peripheral band engages the valve seat so as to seal the peripheral flow aperture, and such that when the solenoid coil is energized, the peripheral band flexes upward sufficiently to unseal the peripheral flow aperture.

17. The solenoid-actuated diaphragm valve according to claim 16, wherein the peripheral band has one or more circumferential flanges that fit snugly into one or more corresponding circumferential notches in the valve seat, thereby securing the circumference of the peripheral band to the valve seat.

18. The solenoid-actuated diaphragm valve according to any of claims 12-17, wherein the plate has at the center of its proximal face a concave depression, into which concave depression the diaphragm flexes upward when the solenoid coil is energized and disengages from the valve seat so as to unseal both of the flow passages.

19. The solenoid-actuated diaphragm valve according to any of claims 12-17, wherein the biasing means is a spring.

20. The solenoid-actuated diaphragm valve according to claim 18, wherein the biasing means is a spring.

21. The solenoid-actuated diaphragm valve according to any of claims 12-17, wherein the central projection has a conical shape.

22. The solenoid-actuated diaphragm valve according to claim 18, wherein the central projection has a conical shape.

23. The solenoid-actuated diaphragm valve according to claim 20, wherein the central projection has a conical shape.

24. A solenoid-actuated diaphragm valve, comprising:
(a) a solenoid coil having a cylindrical interior cavity, within which is slidably inserted a cylindrical armature, which armature is engaged at its distal end by a biasing means, such that when the solenoid coil is not energized, the biasing means urges the armature downward through the interior cavity, and such that when the solenoid coil is energized, the inductance of the solenoid coil draws the armature upward through the interior cavity;
(b) a valve body comprising two flow passages, which flow passages communicate with each other through a valve seat, and which flow passages terminate at the surface of the valve seat in a central flow aperture and a peripheral flow aperture;
(c) a flexible diaphragm having a disk-shaped radial cross-section and a stepped axial cross-section, which diaphragm is attached to the armature, and which diaphragm has three sectors, which are a central core, a medial band, and peripheral band, and which diaphragm is sealingly engageable with the valve seat, such that when the solenoid coil is not energized, the downward action of the armature causes the diaphragm to engage the valve seat so that the central core seals the central flow aperture and the peripheral band seals the peripheral flow aperture, and such that when the solenoid coil is energized, the upward action of the armature causes the diaphragm to disengage from the valve seat so that the central core is displaced upward and unseals the central flow aperture and the peripheral band flexes upward and unseals the peripheral flow aperture;
(d) a conical or frustrum-shaped acute extrusion comprising the central core of the diaphragm, which acute extrusion has an apex that coincides with the axial center of the diaphragm and projects axially downward below the other two sectors of the diaphragm, and which acute extrusion has a base that extends axially upward above the other two sectors of the diaphragm, and which acute extrusion extends radially across almost one-half the diameter of the diaphragm, and which acute extrusion has an axial height that is one-third to one-half the diameter of the diaphragm;
(e) a thin, flexible annular membrane comprising the medial band of the diaphragm, the inner perimeter of which annular membrane surrounds the acute extrusion above the base thereof, and the outer perimeter of which annular membrane is surrounded by the peripheral band of the diaphragm, and which annular membrane has a radial width that is less than 10% of the diameter of the diaphragm, and which annular membrane has a thickness that is approximately 1% of the diameter of the diaphragm; and
(f) a semi-flexible disk rim comprising the peripheral band of the diaphragm, which disk rim extends from the outer perimeter of the annular membrane to the circumference of the diaphragm, and which disk rim has a radial width that is almost one-half the diameter of the diaphragm, and which disk rim has a thickness that is approximately 10% of the diameter of the diaphragm.

25. The solenoid-actuated diaphragm valve according to claim 24, wherein the disk rim has one or more circumferential flanges that fit snugly into one or more corresponding circumferential notches in the valve seat, thereby securing the circumference of the peripheral band to the valve seat.

26. The solenoid-actuated diaphragm valve according to either of claims 24 or 25, wherein the plate has at the center of its proximal face a concave depression, into which concave depression the diaphragm flexes upward when the solenoid coil is energized and disengages from the valve seat so as to unseal both of the flow passages.

27. The solenoid-actuated diaphragm valve according to either of claims 24 or 25, wherein the biasing means is a spring.

28. The solenoid-actuated diaphragm valve according to claim 27, wherein the biasing means is a spring.
